(19) United States
(12) Patent Application Publication
(10) Pub. No.: US 2015/0054717 A1
(43) Pub. Date: Feb. 26, 2015

(54) HEAD-MOUNTED DISPLAY DEVICE

(71) Applicant: OLYMPUS CORPORATION, Tokyo (JP)

(72) Inventors: Ryohei SUGIHARA, Tokyo (JP); Seiji TATSUTA, Tokyo (JP); Teruo TOMITA, Tokyo (JP)

(73) Assignee: OLYMPUS CORPORATION, Tokyo (JP)

(21) Appl. No.: 14/533,587

(22) Filed: Nov. 5, 2014

Related U.S. Application Data
(63) Continuation of application No. PCT/JP2013/062888, filed on May 8, 2013.

(30) Foreign Application Priority Data
May 17, 2012 (JP) 2012-113341

(51) Int. Cl. G02B 27/01

(52) U.S. Cl. CPC G02B 27/0172; G02B 2027/0178
USPC 345/8

(57) ABSTRACT

To improve a balance of weight and improve wearing comfort of a user. A head-mounted display device is provided which includes a display having a display element, an electronic circuit board which controls the display, a battery which supplies power to the electronic circuit board and the display, and a holder which holds these components at the head of the user, and the battery is disposed at an opposite side of the display over a position held by the holder.

### CROSS-REFERENCE TO RELATED APPLICATIONS

This application is a Continuation Application of International Application PCT/JP2013/062888 filed on May 8, 2013, which claims priority to Japanese Application No. 2012-113341 filed on May 17, 2012.

The Contents of International Application PCT/JP2013/062888 and Japanese application No. 2012-113341 are hereby incorporated by reference herein in its entirety.

### TECHNICAL FIELD

The present invention relates to a head-mounted display device.

### BACKGROUND ART

Recently, there have been head-mounted display devices which are mounted at one side of the head and which perform display of an image or video for one eye.

As such head-mounted display devices, there have been disclosed configurations in which a head-mounted display device is attached to a frame of the glasses which can be mounted on the head (see PTL 1 to PTL 4). In all these configurations, a display which is fixed at a temple of the frame of the glasses, is disposed at a front side of the lenses.

### CITATION LIST

### Patent Literature

### {PTL 1}

Japanese Unexamined Patent Application, Publication No. 2010-231119

### {PTL 2}

Japanese Unexamined Patent Application, Publication No. 2008-244658

### {PTL 3}

Japanese Unexamined Patent Application, Publication No. 2010-91748

### {PTL 4}

Japanese Translation of PCT International Application, Publication No. 2001-522064

### SUMMARY OF INVENTION

One aspect of the present invention provides a head-mounted display device which includes a display having a display element, a circuit board which controls the display, a battery which supplies power to the circuit board and the display, and a holder which holds the display, the circuit board, and the battery at the head of a user, and the battery is disposed at an opposite side of the display over a position held by the holder.

With this configuration, because the battery which is located at the opposite side of the display positioned at one side of a holding position of the holder held by the head of the user, serves as a counter balance, it is possible to improve a balance of the head-mounted display device in a longitudinal direction.

### BRIEF DESCRIPTION OF DRAWINGS

FIG. 1 is a plane view and a side view illustrating an outline of a head-mounted display device according to a first embodiment of the present invention;

FIG. 2 is a block diagram illustrating a component layout configuration of the head-mounted display device according to the first embodiment of the present invention;

FIG. 3 is a plane view illustrating a state where the head-mounted display device according to the first embodiment of the present invention is mounted on a temple of the glasses;

FIG. 4 is a plane view illustrating a configuration of a head-mounted display device according to a second embodiment of the present invention;

FIG. 5 is a plane view illustrating a configuration of a head-mounted display device according to a third embodiment of the present invention;

FIG. 6 is a plane view and a side view illustrating a configuration of a head-mounted display device according to a fourth embodiment of the present invention; and

FIG. 7 is a plane view illustrating a configuration of a head-mounted display device according to a fifth embodiment of the present invention and a diagram illustrating a connection part of a battery part and a wiring part.

### DESCRIPTION OF EMBODIMENTS

One embodiment of a head-mounted display device according to the present invention will be described below with reference to the drawings.

### First Embodiment

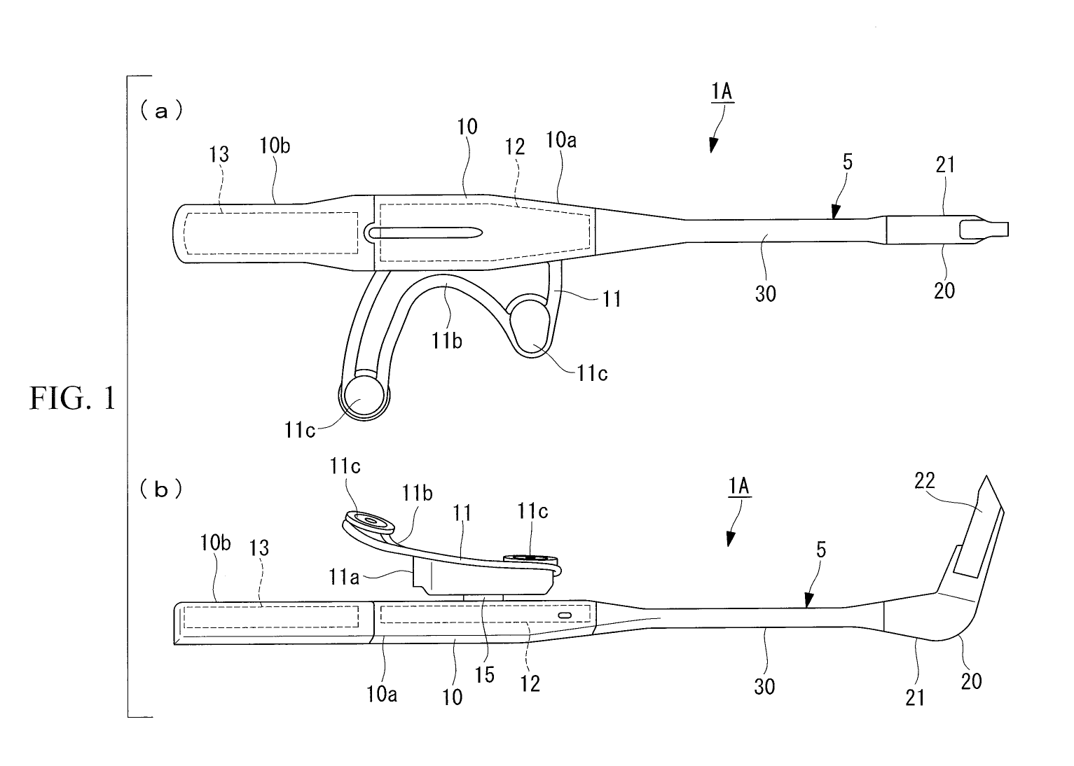

A first embodiment of the present invention will be described below using FIG. 1 to FIG. 3.

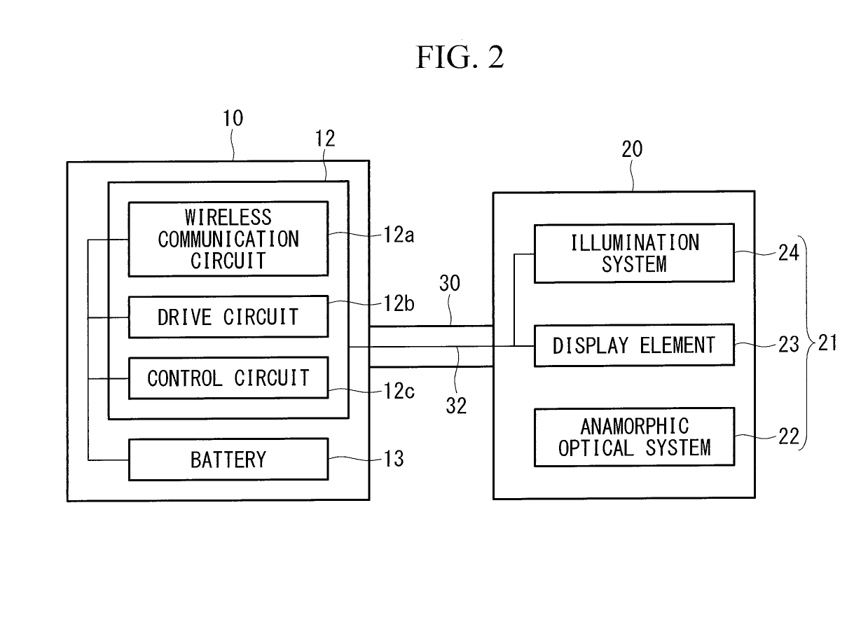

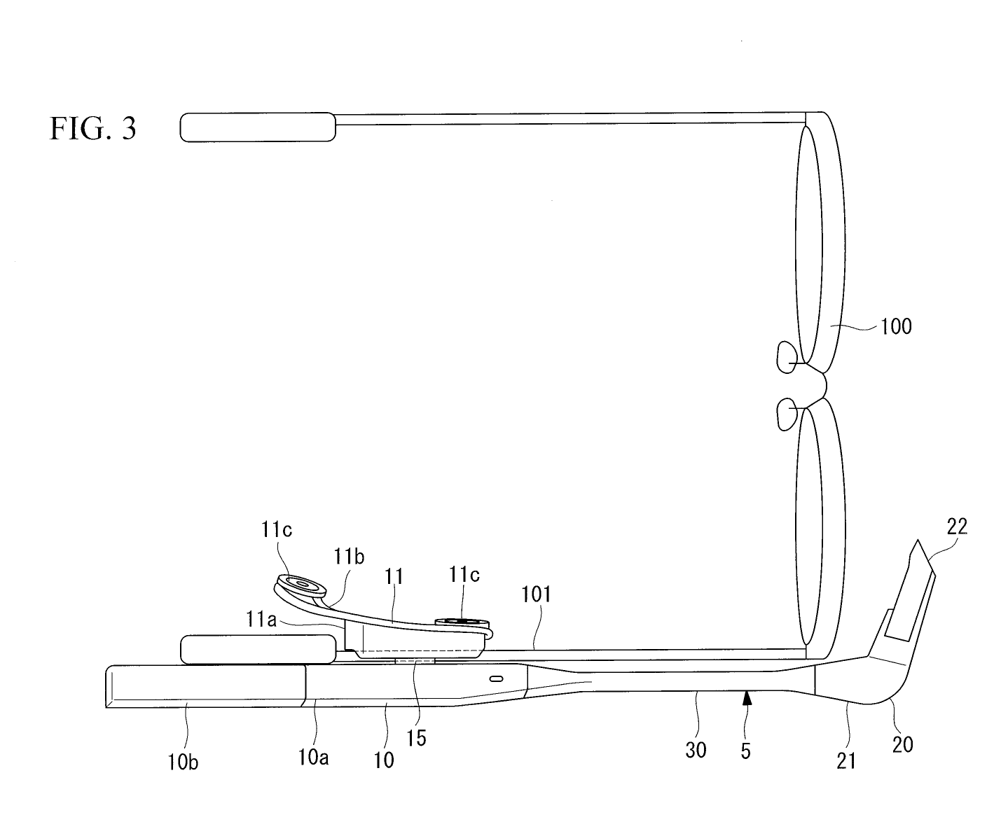

FIG. 1 is a plane view and a side view illustrating an outline of a head-mounted display device 1A, FIG. 2 is a block diagram illustrating a component layout configuration of the head-mounted display device 1A, and FIG. 3 is a plane view illustrating a state where the head-mounted display device 1A is mounted on a temple of glasses 100.

As illustrated in FIG. 1, the head-mounted display device 1A has a display 21 and a holder 5 which holds the display 21 and which is mounted on the head of a user.

The holder 5 has a first chassis 10 which has a head holding member (holding part) to be latched on the head (for example, an ear) of the user, a second chassis 20 at which the display 21 is provided, and a coupling holding part 30 which couples the first chassis 10 and the second chassis 20.

The first chassis 10 has a wiring part 10a which is positioned at a side of the coupling holding part 30 and a battery part 10b which is continuous to the wiring part 10a and which has a substantially constant cross-sectional area.

As illustrated in FIG. 1 and FIG. 2, the wiring part 10a accommodates an electronic circuit board 12 including a wireless communication circuit 12a which receives a signal transmitted from outside through wireless communication such as Bluetooth and Wi-Fi, and a drive circuit 12b and a control circuit 12c which generate and output a signal for driving the display 21. Further, the battery part 10b accommodates a battery 13 for supplying power to the electronic circuit board 12.

As illustrated in FIG. 1, the head holding member 11 includes a clamp part 11a which holds the temple part of the glasses worn by the user between the clamp part 11a and the first chassis 10, a hook 11b which can be latched on the head of the user, for example, the ear of the user, and pads 11c which hit against the head in front of and behind the ear.

The clamp part 11a is attached to an outer periphery of the wiring part 10a of the first chassis 10 through a coupling part (holding position) 15 which has a smaller cross-sectional area than that of the clamp part 11a.

As illustrated in FIG. 3, in such a head holding member 11, when the temple 101 of the glasses 100 is pressed against a portion between the clamp part 11a and the first chassis 10, the coupling part 15 elastically deforms, thereby space between the clamp part 11a and the first chassis 10 becomes large, and the temple 101 is inserted into this space. By putting the temple 101 between the clamp part 11a and the first chassis 10, the head-mounted display device 1A is held by the temple 101 of the glasses 100. It should be noted that the detailed shape and structure of the head holding member 11 are not limited to those described above.

As described above, the head holding member 11 is provided at the wiring part 10a of the first chassis 10, and the battery 13 which is heavy in weight is provided at the battery part 10b of the first chassis 10 positioned at the opposite side of the second chassis 20 over the head holding member 11.

The cross-sectional area of the second chassis 20 becomes gradually large from an end portion at the side of the coupling holding part 30, and an anamorphic optical system 22 which configures the display 21 is provided at the opposite end portion.

The anamorphic optical system 22 is provided so as to be located within a range of vision of the user in a direction the coupling holding part 30 and the second chassis 20 extend in a state where the head-mounted display device 1A is mounted on the head of the user.

As illustrated in FIG. 2, the second chassis 20 incorporates a display element 23 such as an LCD configuring the display 21 and an illumination system 24.

As illustrated in FIG. 1, the coupling holding part 30 has a rod-like shape having a substantially constant outer diameter from the side of the first chassis 10 toward the side of the second chassis 20. It should be noted that the coupling holding part 30 can be attached to and removed from the first chassis 10 at the end portion at the side of the first chassis 10.

Further, as illustrated in FIG. 2, the coupling holding part 30 incorporates a wiring 32 which electrically connects the electronic circuit board 12 within the first chassis 10 and the display element 23 within the second chassis 20.

The coupling holding part 30 preferably has flexibility which allows free bending by the hand of the user and shape retaining property which allows the shape to be retained as is when the hand is released. With these properties, the user can adjust the position and the orientation of the second chassis 20 with respect to the first chassis 10 appropriately by bending the coupling holding part 30. Specifically, the position and the orientation of the second chassis 20 are adjusted, for example, in order to position an optical axis of the anamorphic optical system 22 to the pupils of the user, change the position of the display screen in the vision of the user by changing an angle of the optical axis of the anamorphic optical system 22 with respect to the pupils of the user, and evacuate the anamorphic optical system 22 to a position which does not interfere with the vision of the user when the anamorphic optical system 22 is not used.

The head-mounted display device 1A is configured so that a length from the coupling part 15 to the display 21 is totally longer than a length from the coupling part 15 to the battery part 10b, and so that a length from the position of the center of gravity in the longitudinal direction which connects the display 21 and the battery part 10b to the position of the center of gravity of the display 21 is longer than a length from the position of the center of gravity in the longitudinal direction which connects the display 21 and the battery part 10b to the position of the center of gravity of the battery part 10b.

In such a head-mounted display device 1A, a video (including an image) signal wirelessly transmitted from an external video reproduction device, or the like which uses, for example, a personal computer, TV, an HDD (Hard Disk Drive) and a DVD (Digital Versatile Disc) is received at a wireless communication circuit 12a of the electronic circuit board 12 provided within the first chassis 10. The video signal received at the wireless communication circuit 12a is converted into a drive signal for driving the display element 23 of the display 21 at the drive circuit 12b. The drive signal generated at the drive circuit 12b as described above is transmitted to the display 21 of the second chassis 20 through the wiring of the coupling holding part 30.

At the display 21, the display element 23 is driven by the transmitted drive signal, and the display element 23 displays the video according to the drive signal. The video displayed at the display element 23 is guided to the anamorphic optical system 22 by a light emitted from the illumination system 24, and the guided video is enlarged and guided to the pupils of the user at the anamorphic optical system 22, so that the user can view the enlarged virtual image.

According to the head-mounted display device 1A as described above, the head holding member 11 is provided at the wiring part 10a of the first chassis 10, and the battery 13 which is heavy in weight is provided at the battery part 10b of the first chassis 10 positioned at the opposite side of the second chassis 20 over the coupling part 15. With this configuration, the battery 13 can serve as a counter balance of the display 21, and the center of gravity in the longitudinal direction of the head-mounted display device 1A can be positioned in the vicinity of the coupling part 15 of the head holding member 11. As a result, a favorable balance of weight can be achieved between the display 21 and the battery 13, so that it is possible to prevent the weight of the head-mounted display device 1A from concentrating on the front end portion of the glasses 100 when the user wears the head-mounted display device 1A. Further, by positioning the center of gravity of the head-mounted display device 1A in the vicinity of the coupling part 15 also in a horizontal direction of the glasses 100, most of the weight of the head-mounted display device 1A can be held by the ear of the user, so that it is possible to prevent the glasses 100 from being lopsided by its weight.

In this manner, it is possible to provide excellent wearing comfort and usability when the user wears the above-described head-mounted display device 1A on the head while the head-mounted display device 1A is attached to the glasses 100.

Further, by adopting a configuration where the first chassis 10 incorporates the drive circuit 12b and the control circuit 12c, it is possible to reduce the weight of the second chassis 20. This configuration makes it easier to further concentrate the position of the center of gravity of the head-mounted display device 1A in the vicinity of the head holding member 11, so that it is possible to obtain the above-described effect more reliably.

While the configuration of the head-mounted display device 1A has been illustrated in the above-described first embodiment, it is also possible to adopt configurations which will be described in the following plurality of examples other than the above-described configuration. It should be noted that in the following description, because an overall configuration of the head-mounted display device 1A is the same as that of the above-described first embodiment, and only the detailed configuration is different, the same reference numerals will be assigned to the components common with those in the above-described first embodiment and the explanation thereof will be omitted.

### Second Embodiment

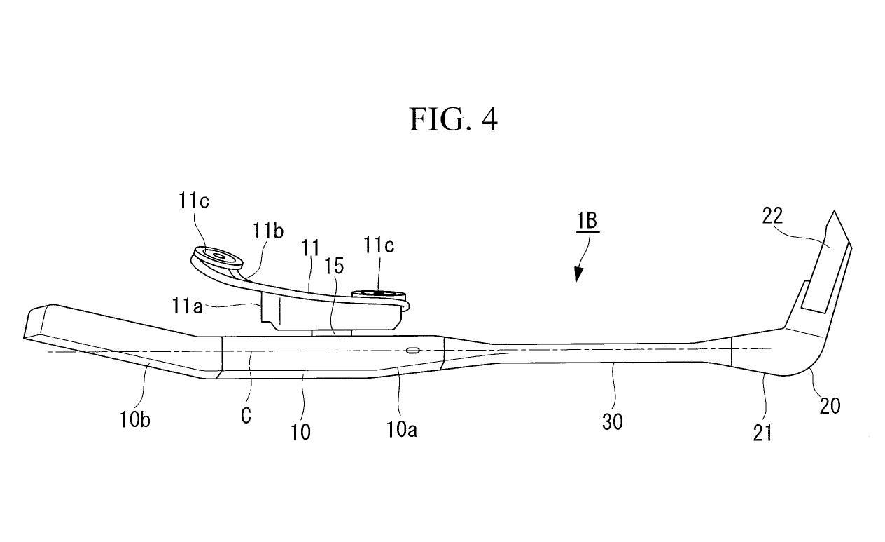

As illustrated in FIG. 4, in a head-mounted display device 1B in the present embodiment, the battery part 10b of the first chassis 10 is provided to tilt toward a side close to the head of the user (a side where the head holding member 11 is provided at the wiring part 10a) with respect to a central axis C of the wiring part 10a and the coupling holding part 30 in a state where the user wears the head-mounted display device 1.

With this configuration, the center of gravity of the head-mounted display device 1B can be positioned close to the head of the user in a plane view, so that it is possible to realize further stable wearing comfort.

Further, it is also possible to configure the coupling part 15 to be able to slide along the longitudinal direction (a direction connecting the first chassis 10 and the second chassis 20) with respect to the first chassis 10. This configuration can be realized by forming a groove extending in the longitudinal direction at the first chassis 10 and configuring the coupling part 15 to be able to slide along this groove.

With this configuration, it is possible to adjust the position of the display 21 in the longitudinal direction according to the size of the head of the user.

### Third Embodiment

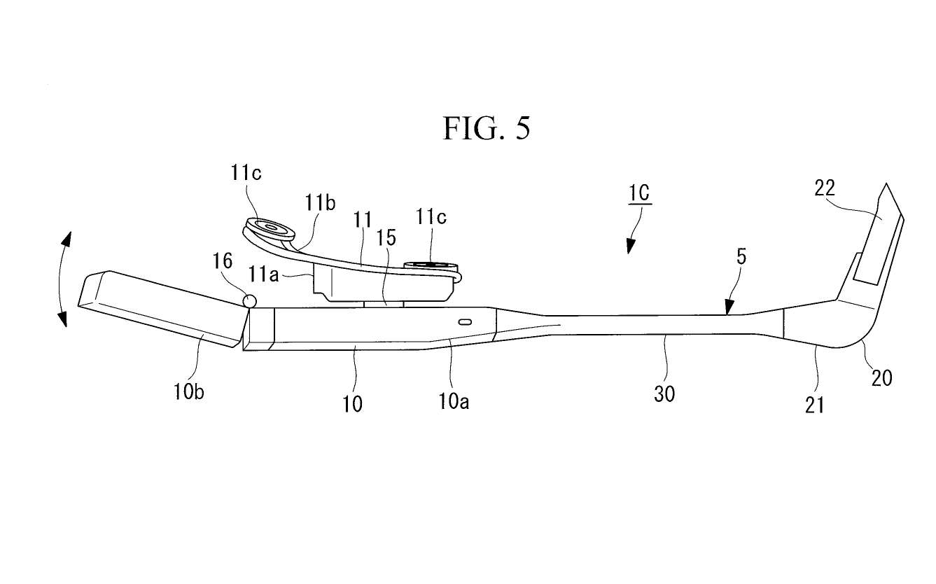

As illustrated in FIG. 5, in a head-mounted display device 1C in the present embodiment, the battery part 10b of the first chassis 10 is coupled to the wiring part 10a so as to be tiltable in a direction approaching the head of the user via a hinge 16 provided at a side surface at the side the head holding member 11 is provided.

It should be noted that at the part of the hinge 16, the battery 13 of the battery part 10b is electrically connected to the electronic circuit board 12 of the wiring part 10a using a wiring which is not illustrated.

According to this configuration, the angle of the battery part 10b can be appropriately changed according to the size of the head, the hairstyle, or the like of the user, so that it is possible to realize a favorable balance of weight by moving the battery part 10b as close to the head of the user as possible.

### Fourth Embodiment

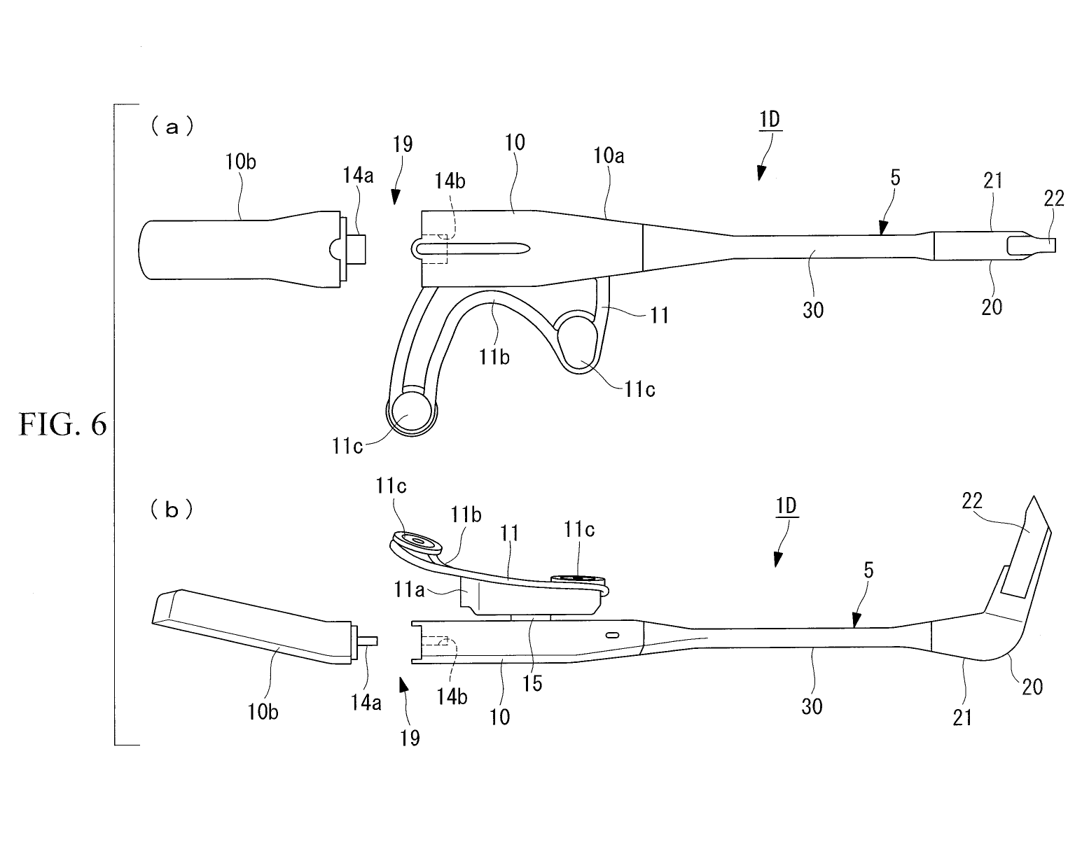

As illustrated in FIG. 6, in a head-mounted display device 1D in the present embodiment, the battery part 10b of the first chassis 10 can be attached to and removed from the wiring part 10a. Here, the connection part 10 of the battery part 10b and the wiring part 10a is preferably located at a posterior portion of the coupling part 15 (at a side of the battery part 10b).

The battery part 10b can be also configured as a battery unit which is integrated with the battery 13. The battery part 10b and the wiring part 10a can be mechanically and electrically connected to each other through connectors 14a and 14b provided at the connection part 19.

Further, the battery part 10b and the wiring part 10a are configured to have the same cross-sectional shape so as to engage with each other at the connection part 19, and to ensure waterproof property at the mating surface.

With this configuration, it is possible to provide the same operational effect as that of the above-described first and second embodiments, and, in addition, it is also possible to attach and remove only the battery part 10b, so that it is possible to remove the battery 13 of the battery part 10b as necessary to charge the battery 13. Further, when the head-mounted display device is not used, by removing the battery part 10b, it is possible to accommodate the head-mounted display device compactly.

Still further, it is possible to replace the battery part 10b with an auxiliary battery part 10b or a battery part 10b with higher capacity.

When the battery part 10b is replaced with the battery part 10b with higher capacity, if the battery part 10b with higher capacity is heavier than the battery part 10b, it is preferable to adopt a configuration where the coupling part 15 can slide as described in the above-described second embodiment so as to be able to adjust the position of the center of gravity of the head-mounted display device 10 in the longitudinal direction.

### Fifth Embodiment

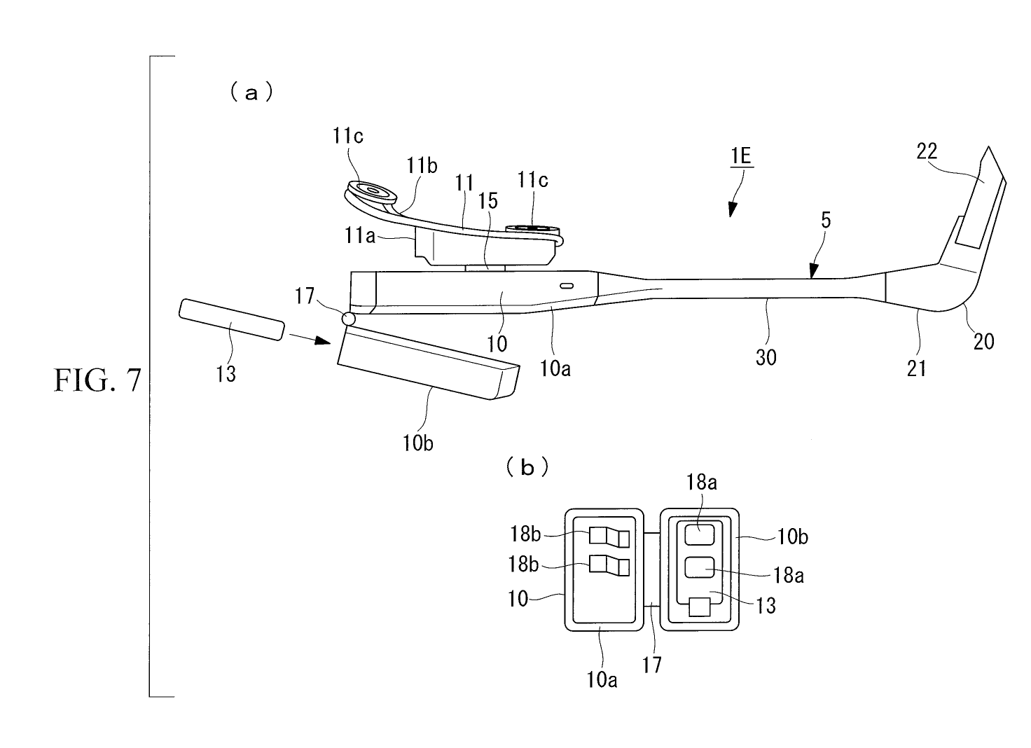

As illustrated in FIG. 7, in a head-mounted display device 1E in the present embodiment, the battery part 10b of the first chassis 10 is configured to be able to turn with respect to the wiring part 10a via a hinge 17 so that the battery 13 accommodated in the battery part 10b can be inserted into and removed from the battery part 10b. It should be noted that in the present embodiment, the battery part 10b may turn in any direction via the hinge 17.

At this time, electrodes 18a and 18b are provided at the end faces at the side of the battery 13 and the wiring part 10a, so that the both electrodes contact each other and are electrically conductive with each other when the battery part 10b is closed.

Further, the battery part 10b and the wiring part 10a are configured to have the same cross-sectional shape so as to engage with each other at the connection part and to ensure waterproof property at the mating surface.

With this configuration, it is possible to attach and remove or replace the battery 13 as appropriate by opening the battery part 10b.

It should be noted that the present invention is not limited to the configurations as described in the above-described embodiments, and it is possible to modify the configuration or add or delete components within a range which does not depart from the scope of the present invention.

For example, while, in the head-mounted display devices 1A to 1E, in a side view, the battery part 10b is configured to extend in substantially the same direction as the longitudinal direction of the wiring part 10a and the coupling holding part 30, the battery part 10b may be provided to extend, for example, obliquely downward or vertically downward from the side of the wiring part 10a. It should be noted, however, that by providing the battery part 10b so as to extend in substantially the same direction as the longitudinal direction of the wiring part 10a and the coupling holding part 30 as described in the above-described embodiments, it is possible to increase moment by the battery part 10b with respect to the position of the center of gravity of the head-mounted display devices 1A to 1E, so that it is possible to efficiently improve a balance of weight using the battery part 10b.

Further, the head-mounted display devices 1A to 1E may be configured to be latched directly on the ear of the user, or the like instead of being latched on the temple 101 of the glasses 100.

Further, it is also possible to appropriately combine the configurations described in the above-described embodiments.

On the basis of the embodiment described above, inventions as follows are derived.

To solve the above-described problems, the present invention employs the following solutions.

One aspect of the present invention provides a head-mounted display device which includes a display having a display element, a circuit board which controls the display, a battery which supplies power to the circuit board and the display, and a holder which holds the display, the circuit board, and the battery at the head of a user, and the battery is disposed at an opposite side of the display over a position held by the holder.

With this configuration, because the battery which is located at the opposite side of the display positioned at one side of a holding position of the holder held by the head of the user, serves as a counter balance, it is possible to improve a balance of the head-mounted display device in a longitudinal direction.

In the above-described aspect, an arrangement is also possible in which a length from the position held by the holder to the display becomes longer than a length from the position held by the holder to the battery.

By disposing the holding position or a position of the center of gravity of the whole device at a posterior side, it is possible to reduce weight applied on the front side of the frame of the glasses.

In the above-described aspect, the holder is a portion to be attached to the head of the user or the temple of the glasses mounted at the head of the user and may be disposed in the vicinity of the position of the center of gravity in the longitudinal direction which connects the display and the battery.

By positioning the center of gravity of the head-mounted display device in the vicinity of the portion to be attached to the head of the user or the temple of the glasses, the head-mounted display device has an excellent balance in the longitudinal direction.

In the above-described aspect, the circuit board may be provided between the display and the battery.

With this configuration, it is possible to reduce weight of the display compared to a configuration in which the circuit board is integrally provided at the display, so that it is possible to avoid concentration of the weight at a front end portion of the head-mounted display device.

In the above-described aspect, the circuit board is preferably provided in the vicinity of the holding position held by the head of the user.

With this configuration, it is possible to keep a favorable balance of weight of the head-mounted display device.

In the above-described aspect, the battery is preferably disposed at a posterior side of the position of the center of gravity in the longitudinal direction which connects the display and the battery.

With this configuration, it is possible to keep a favorable balance of weight of the head-mounted display device.

In the above-described aspect, an arrangement is preferable in which a length from the position of the center of gravity in the longitudinal direction which connects the display and the battery to a position of the center of gravity of the display is longer than a length from the position of the center of gravity in the longitudinal direction which connects the display and the battery to the center of gravity of the battery.

With this configuration, because the holding position or the position of the center of gravity of the whole device is disposed at a posterior side, it is possible to reduce weight applied to the front side of the frame of the glasses.

In the above-described aspect, the battery may be attachable and removable at a position at a posterior side of the position of the center of gravity in the longitudinal direction which connects the display and the battery.

In the above-described aspect, the battery may be disposed so that a longitudinal direction of the battery is along a direction which connects the display and the battery.

With this configuration, it is possible to increase moment by the battery centering around the position of the center of gravity of the head-mounted display device, which makes it easier to achieve a balance of the head-mounted display device in the longitudinal direction.

In the above-described aspect, the battery may be disposed so as to tilt toward a side which approaches the head in a state where the head-mounted display device is mounted on the head of the user.

With this configuration, the center of gravity of the head-mounted display device can be positioned closer to the head in a plane view, so that it is possible to improve a balance of the weight.

In the above-described aspect, the battery may be provided to be tiltable toward a side approaching the head in a state where the head-mounted display device is mounted on the head of the user. With this configuration, it is possible to adjust an angle of the battery according to the size of the head, hairstyle, and the like of the user.

### Advantageous Effects of Invention

According to the present invention, it is possible to provide an advantageous effect of improving a balance of the weight of the head-mounted display device and improving wearing comfort of the user.

### REFERENCE SIGNS LIST

1A to 1E head-mounted display device
5 holder
10 first chassis
10a wiring part
10b battery part
11 head holding member (holding part)
11a clamp part
11b hook
11c pad
12 electronic circuit board (circuit board)
12a wireless communication circuit
12b drive circuit
12c control circuit
13 battery
14a, 14b connector
15 connection part (holding position)
16 hinge
17 hinge
18a, 18b electrode
19 connection part
20 second chassis
21 display
23 display element
24 illumination system
30 coupling holding part
100 glasses
101 temple

1. A head-mounted display device comprising:
a display having a display element;
a circuit board which controls the display;
a battery which supplies power to the circuit board and the display; and
a holder which holds the display, the circuit board, and the battery at the head of a user,
wherein the battery is disposed at an opposite side of the display over a position held by the holder.

2. The head-mounted display device according to claim 1, wherein a length from the position held by the holder to the display is longer than a length from the position held by the holder to the battery.

3. The head-mounted display device according to claim 1, wherein
the holder is a portion to be attached to the head of the user or a temple of glasses mounted on the head of the user, and
the portion to be attached is disposed in the vicinity of a position of a center of gravity of the head-mounted display device in a longitudinal direction which connects the display and the battery.

4. The head-mounted display device according to claim 1, wherein the circuit board is provided between the display and the battery.

5. The head-mounted display device according to claim 4, wherein the circuit board is provided in the vicinity of the position held at the head of the user by the holder.

6. The head-mounted display device according to claims 1, wherein the battery is disposed at a posterior side of the position of the center of gravity in the longitudinal direction which connects the display and the battery.

7. The head-mounted display device according to claims 1, wherein a length from the position of the center of gravity in the longitudinal direction which connects the display and the battery to a position of a center of gravity of the display is longer than a length from the position of the center of gravity in the longitudinal direction which connects the display and the battery to a position of a center of gravity of the battery.

8. The head-mounted display device according to claims 1, wherein the battery is provided so as to be attachable and removable at a posterior position of the position of the center of gravity in the longitudinal direction which connects the display and the battery.

9. The head-mounted display device according to claims 1, wherein the battery is disposed so that a longitudinal direction of the battery is along a direction which connects the display and the battery.

10. The head-mounted display device according to claims 1, wherein the battery is disposed to tilt toward a side approaching the head in a state where the head-mounted display device is mounted on the head of the user.

11. The head-mounted display device according to claims 1, wherein the battery is provided to be tiltable toward a side approaching the head in a state where the head-mounted display device is mounted on the head of the user.
